(19) United States
(12) Patent Application Publication
(10) Pub. No.: US 2012/0174728 A1
(43) Pub. Date: Jul. 12, 2012

(54) METHOD FOR INCREASING RESONANCE OF INSTRUMENT AND THE INSTRUMENT

(76) Inventors: Hyeon Su Oh, Seoul (KR); Min Sook Jeong, Seoul (KR)

(21) Appl. No.: 13/384,041

(22) Filed: Jan. 13, 2012

Related U.S. Application Data
(63) Continuation of application No. PCT/KR2010/004639, filed on Jul. 16, 2010.

(30) Foreign Application Priority Data
Jul. 16, 2009 (KR) 10-2009-0065098
Aug. 24, 2009 (KR) 10-2009-0078241
Nov. 10, 2009 (KR) 10-2009-0108015

(51) Int. Cl. G10C 3/06; G10D 3/02; G10D 9/00

(52) U.S. Cl. 84/193; 84/380 R; 84/294

(57) ABSTRACT

A method for increasing the resonance of an instrument such as a woodwind instrument having a cap holder inside and a pad coupled to the cap holder comprises: an agitation step for agitating a mixture of a conductive medium that contains at least one of platinum, gold, silver, copper, nickel, bronze, brass, phosphor bronze with solid silicon; a mixture heating step for heating the agitated mixture; a coagulation step for naturally cooling the heated mixture and coagulating into a solid; a mixture pulverization step for pulverizing the mixture; a mixture application step for applying the mixture to the inside of the cap holder; and a pad attaching step for attaching a pad to the interior of the cap holder after the mixture application step.

### BACKGROUND

The present invention relates to a method for increasing resonance of instrument and the instrument, and more specifically, to a resonance-intensifying method for musical instruments and those achievable with the use of such method by applying the instruments with a conductive medium produced in the form of a mixture of resonance-intensifying substances.

Sound produced by musical instruments takes advantage of vibration of air, allowing musical passages to be an art of sound, insomuch as all kinds of sound including musical sound comes from vibration of air. Woodwind instruments convert a moving column of air into musical sound by controlling flowing of air streams and utilizing the effect of vibration.

Namely, a piece of musical performance relies on vibrational pulses of air, which is the physical phenomenon affordable for listening to it through auditory organs with the help of air as a medium that carries vibrations created by instrument(s).

The source of either musical sound or orchestral melody basically arises from breathing of the player whereby vibrations are converted into sound and acoustic tonal excitation, which demonstrates that the core essential as per musical means or instruments lies in how profoundly to modulate such vibrations.

The sound arriving at human's hearing organs is defined as a mechanical wave variably in terms of air flux that results from changes in air pressure, causing the vibration of the particles of the medium (air) through which the sound wave is moving, wherein the motion of air particles propelled by performance through instrument(s) can be called musical sound.

In this regard, the lifecycle of a sound passes through 3 stages, i.e. generation, propagation and extinction, amongst which the stage of sound generation is of paramount importance in the viewpoint of the woodwind instrument player.

More specifically, in light of the fact that the sound making through vibrations generated by woodwind instruments is as vital in importance as how well breathing is made from the player's lungs, technical concerns of enriching tonal expressions and improving sound quality as for woodwind instruments include techniques such as amplification of sound volume to provide better musical flavor, extension of time values (reverberation time) and expanded dynamic range for flexible representations from soft sound to high sound commensurate with blows of breath by a player.

Vibrations arising from waves of air streams which are created by woodwinds such as saxophones, flute, clarinet, oboe and bassoon, as well as vocal cords and strings of violin are classified into self-induced vibrations, where cycles or amplitudes of sound waves are self-determined via interactions between an oscillatory system and its surrounding condition though energy is continually supplied externally to sustain oscillation of the system. Such vibrations are also damped oscillation inasmuch as vibrations become naturally extinct.

Except under special circumstances there is a limit to how to elicit sufficient vibration only through breaths of the wind instrument player; therefore, advanced technique by facilitating a conductive medium to the component of the instrument acting as a soundboard is implemented in order to strengthen periodicity of vibrations for creating and modulating sound with better tonal quality.

Acoustic resonance indicates the tendency of an acoustic system to oscillate by absorbing vibrational energy from other system where the energy is easily transferred if those systems are mutually connected.

As such, resonance means that vibrational waves travel from one to another along with transfer of vibrational energy, in which case a stronger resonant effect can be obtained with the closer the frequencies are between frequency of initial vibrational energy and natural frequency of an object such vibrational energy is subjected to.

In other words; the lack of vibrating strengths produced only through breaths of the player and an instrument itself is supplemented by a conducting medium, such as a resonating chamber facilitated to the instrument, in a manner that amplifies and conveys energy to the body of the instrument, increases periodicity of vibrations by maximizing them, and makes it easy for the player to perform a piece of music by adjusting, for its own, balance of sound quality.

In this sense musical performance is the behavior to modulate and convert vibrations into artistic sound in such manner it elicits emotions by representing such vibrations to certain melodic sounds, where the aforesaid conducting medium plays a key role in enriching vibrations and producing the echoing effect; therefore, a piece of magnificent music performance is achieved by taking full advantage of such echoing and timbre artistically.

In as much as the good sense of musical sound can be produced by strengthening vibrations to have the periodic properties, it is usual to induce the effect of musical resonance by directly connecting a conductive medium to the portion of an instrument in charge of amplification, where stronger vibrations may be made if the resonant effect is applied partially to the essential portion of acoustic and sound amplification, as the basic setting for better musical performance. If the degree of responsiveness in an instrument is raised via a conductive medium, it is expected the phenomenon alleviating musical notes is mitigated and musicianship is improved by making it easy to produce such sophisticated tones as so in three octaves and re in low-pitched tone, which is difficult as for normal players. In addition, it leads to better musical reverberation, smoothing the flow of pitches to pitches as natural.

To provide a good sense of musical performance, as mentioned above, by amplifying loudness and altering timbre as appropriate, while expressing time values (reverberation time) and pitches in a desired way, the periodicity of vibrations must be high, thus requiring a technique that improves sound volume, time values and pitches for maximizing the resonance effect and enhancing the periodic property of vibrations by varying the construction of a conductive medium in a way that applies mixture of a conductive medium to the interior, not the exterior, of a pad cap in an woodwind instrument which assumes a core role of amplifying vibrations.

An appropriate conducting medium offers extended reverberation time through an echo-reverb function of mixer and by amplifying sound volume as if a microphone is connected with an amp, while being able to change timbre depending on the type of the conducting medium.

In general, a player in an attempt to perform recording is provided with the help of acoustic electronic equipment such as amp, mixer and microphone for the sake of supplementing shortcomings originated from an instrument itself,

Despite the foregoing, it is intrinsically important to enhance functionality of a musical instrument itself to improve sound quality in live performance of music that is made in an analog state, accordingly driving professional musicians inclined to highly expensive instruments for better quality of sound in their performances.

Exquisite instruments as hinted as above indicate those with good resonators that enable to create excellent quality of sound, rich timbre and abundant reverberation time.

In addition, those having the good echoing capacity indicate instruments in which the periodicity of vibrations is regularly exhibited, which addresses that the true sense of an exquisite instrument must have regularity in terms of periodicity of vibrations.

Therefore, the most fundamental task as for instrument builders relates to such core principle of how to raise periodicity of Vibrations as to musical instruments.

In addition to that, ways for creating and modulating timbre are equally important.

The matter of timbre has been by far dealt mainly focusing on the material of an instrument. Though admitting it renders a fundamental task to be sought for by instrument builders, quality of sounds, or timbre, can be greatly improved, in a directly influential manner, subject to how and what conductive medium is selected and applied to the component of an instrument that acts as a soundboard. If constructed suitably, the style of timbre can be much more diversely and manifoldly exhibited by a player, depending on his or her taste and intention, for example, cool timbre, serious timbre, cool and serious timbre, light timbre or dark timbre.

Roughly speaking, the periodicity in sound is prerequisite for musical sound, expelling nuisance sound with irregularity (aperiodicity) produced except by percussion instruments as noise, which demonstrates that musical instruments except percussions make the best of pitches (high and low pitches) of sound having periodic vibrations; more specifically, those are tools fully availing of periodic vibrations for conversion into musical sound and controlling such to be musical sound in harmony.

The inventive technique as mentioned above is one to make instruments towards amplifying loudness, improving timbre and cultivating periodicity in vibrations, as the fundamental to make available “exquisite”, or maybe better, sound by creating and modulating unique sound woodwinds can exert; simply speaking, the technique makes it possible to manufacture woodwind instruments with better sound quality by controlling intensity and periodicity of vibrations dependent on the type and magnitude of conducting media.

In improving quality of sound as mentioned above, all kinds of sound including musical sound originate from “vibrations of air, thus making it quite natural for acoustic experts to consider music as the vibrational phenomenon in the air.

The scientific sense in a phrase of “make a sound” is to cause changes in pressure of air around the sound generating source; more specifically, the source stirs up density of its circumferential air which in turn makes air particles to move.

Such vibrations gradually propagate through air wherein we call a “sound” when they are sensed by our auditory organs.

Vibrations mentioned as above can be classified, in acoustic terms, into sound having “periodicity” and sound having “aperiodicity”.

The meaning of periodic sound is that pulsing patterns of sound are regularly repeated and sound produced in such manner is expressed as musical sound; namely, the criterion to distinguish musical sound from non-musical sound is whether sound has periodicity particularly with high regularity in vibrations.

Meanwhile, non-periodic sound has no specific loudness. The acoustic distinction between musical sound and nuisance sound (or noise) can be made only through periodicity in vibrations.

Whereas percussion instruments produce sound with no pitches (highness and lowness in sound) caused by aperiodic vibrations, string instruments and wind instruments produce sound with pitches (highness and lowness in sound) caused by periodic vibrations.

In this regard, the wording of periodicity in certain vibrations means that vibrations have repeated and regular patterns continuously in their propagation.

One hardly applies exactly same magnitude of force repeatedly when playing an instrument, so sounds produced by such manner cannot be perfectly identical one by one; however, practicing to play an instrument for bars of music can reduce gaps of variation in each play and make steady sounds, which addresses that the string or woodwind instrument player is required to pay toil and sweat for mastering an instrument.

Besides such endeavor for being at good command of an instrument, it is all the more important to devise a musical instrument worthy of exerting better periodicity in vibrations enabling the player to produce sounds more easily and stably so that he or she can perform pieces of music with high standard in a shorter period of exercises; likewise, an instrument having better and higher level of periodicity in vibrations makes it possible to sensitively respond what is intended by the player and differentiate each partial tones (low, median and high sounds) with clearer and superb sound quality, all of which is a basic core and prerequisite for a masterpiece instrument.

If periodicity in vibrations pursuant to an instrument is enhanced as mentioned above, it is achievable to enlarge the dynamic range so as to profoundly express pitches (highness and lowness in sound) from the low portion to the high portion of sound, enrich loudness, improve time value to be sufficiently long reverberant time, soften and make clear timbre, wherein a conductive medium for bettering periodicity in vibrations shall be constructed directly to the interior of the component acting a soundboard in a tight and integrated manner to strengthen the resonance effect as desired.

What is highly important herein is that a conductive medium be ‘tightly and closely’ constructed to the ‘interior’ of a soundboard or the equivalent. Only applying to the interior of the soundboard (i.e. inside of a cap holder) can accelerate the effect of resonance and quality of sound. This is because the resonance effect can be maximized when two media are directly connected with each other. If applied to the outside part, the resonance effect is weakened, giving rise to problems as for sound quality (in view of pitches, time value and loudness).

However, woodwinds classified as above are not easy for normal people to play. In particular, the conventional technology to manufacture woodwind instruments resorts to the material to make an entire profile for creating broad sense of sounds, which conversely demonstrates that such craftsmanship has intrinsic handicaps in delicately controlling part by part pitches (highness and lowness in sound), loudness (intensity of sound), time value (reverberation time of sound) and timbre (color of sound).

Due to such reasons, existing woodwinds cannot avoid disadvantages such as poor reverberation and echo sound, narrow width of sound, short dynamic range that can cover from soft sound to strong sound, low level of loudness and unclear and raspy sound.

What is worse includes deviations in the range of high, median and low sounds, which means it is poor to produce specific register of sound while it is good to produce another specific register of sound, in addition to imbalances of sound quality and coarse, non-soft and noisy characteristics with low loudness; accordingly, the player cannot but feel constrained to express himself or herself through blowing of the instrument given its poor capability in generating specific range of sound, while the audience feels squawky in listening arising from lack of reverberation and echoing effect. There are four musical elements, i.e. loudness, time value, pitch and timbre likely to develop depending on improvement of periodicity of vibrations and the properties of a conducting medium.

Pitches as defined herein can be expressed or measured as “high and low”, loudness as “big and small”, and time value as “long and short”.

Contrary to those, timbre in particular has the “multi-dimensional” characteristic intrinsically as a means of not being simple in measuring it, which makes it difficult to define it precisely. The phonetic expressions regarding this include light sound, dark sound, light and at the same time sincere sound and other wide spectrum of sound styles.

The typical four benefits, as far as woodwinds are concerned, that can be derived from this invention provide farther advanced representations in the dynamic range with respect to pitches of sound, affluence with respect to loudness, better reverberation enough to produce sufficient level of echoing with respect to time value and clear-cut vividness with respect to timbre that leads to more beautified performance.

In the meantime, sound can be briefly expressed as vibrations of air, let alone, musical sound that can be said as the phenomenon of air vibrations.

The types of sound caused by vibrations can be divided into sound having continually repeating periodicity and sound having non-regular aperiodicity in its vibrations.

As per the foregoing, the former is featured by having pitches (highness and lowness in sound) and the latter by having no specific pitches. Wind instruments and string instruments are grouped to periodicity and percussions to aperiodicity.

Musical instruments are tools to control and modulate vibrational phenomena into beautiful strings of sound. Therefore, an instrument can be briefed as a controller of vibrations, which argues that an instrument capable of creating and controlling vibrations to the best sufficient extent is a good instrument.

To produce good sound, to begin with, there must generate vibrations in an instrument both sufficiently and effectively. The breakthrough to start up vibrations lies in breaths of the player that act to amplify vibrations within an instrument as for wind instruments, while the breakthrough as for string instruments starts from a bow of the player.

As for wind instruments, sound is amplified in the pipe of the instrument while it is amplified in the wooden chamber as for string instruments, wherein timbre varies subject to material of such sound generating systems.

Resonance indicates the tendency of markedly increasing amplitudes for an acoustic system by periodically absorbing external energy (force) that has the same frequency with the system's natural frequency (eigenfrequency). By taking advantage of such phenomenon, sound with weak waves can be amplified to sound having stronger waves.

In addition, acoustic resonance is maximized by exchanging vibrational energy with the more closely connected the oscillating systems are, wherein exchange of the energy becomes easier due to resonance if frequencies in two oscillating systems are mutually identical.

To make vibrations only through breaths blown by the wind instrument player is limited, so a complex setting of a conductive medium to the inside of a soundboard (cap holder) shall be used to induce the resonance effect by utilizing energy generated by that conductive medium so that intensity and magnitude of vibrations can be dually expanded together with breaths of the player.

Such devised setting offers improved amplification of time value and loudness, in addition to enhanced timbre subject to the type of conductive medium in which case it is of utmost importance to directly bond the conductive medium to an object acting a soundboard within the instrument so as to maximize the effect of resonance. It is designed to make energy producible by the conductive medium to be transferred to the instrument in order to strengthen intensity of vibrations thanks to the resonance effect.

Up to now until the current invention is devised, the determinant in conjunction with timbre relies on the material (type of metals or wood) of a sound-generating system, thus making it difficult to make up for specific range of sound that exhibits poor sound quality (either in terms of loudness, pitch and time value).

Now, a novel technique proposed by this invention is able to modulate or make better the sound range, either in specific register of sound or an entire spectrum of sound quality, as well as create newer and higher level of magnificent sound quality.

The features involving this invention are to maximize the resonance effect by directly and tightly connecting a conductive medium to the interior of soundboard (cap holder) of an instrument, not adopting any other indirect configuration, wherein a variety of conductive media as appropriate can be incorporated as intended by an instrument builder to create new and different timbre.

This novel invention not only energizes conventional sound quality and timbre available in conventional instruments, but provides refreshed sound quality and timbre differentiated from them.

Typically, conventional woodwinds constructed as above adopt pads in charge mainly of resonance (echoing phenomenon of sound), which are inserted into the inside of cap holder in a manner that just fixes it with the use of glue.

In order to fix pads into the inside of cap holder as mentioned above an adhesive such as glue is applied to the back of aforesaid pads through which the pads are adhesively bonded to the internal surface of cap holder.

The design as above, that is a method of bonding pads to the inside of cap holder, acts as the fundamental requirement for performing sounds an instrument inherently has, not aiming for improving sound quality of the vibrational instrument given lack of resonance. In other words, the conventional sound amplification method is an indirect one with the weakened effect of resonance.

Therefore, inherent sound as intended in the conventional instruments is imperfect in part, making four elements of sound quality instable.

The current invention is applicable for various string instruments, for example, violin, viola, cello and double bass, including but not limited to, piano towards making resonance superb.

Amongst instruments as enumerated above, violin basically comprises pegs, bridge, sound post, finger board, string and chinrest.

In this regard, pegs are easily susceptible to be slipped or stiffened subject to change in humidity.

In the case where pegs are slipped out, they shall need to be pulled out to lightly rub them with the use of steel wool or fine sandpaper; meanwhile, in the case of not well being moved, dry soap or pegdope is applied to the contact between pegs and peghole to make their movement smooth.

The use of chalk or 4B pencil may be made as a simple method where necessary, in which there is a problem, however, that pegbox is likely to be broken if applied by excessive force.

In addition, the bridge is an important component of a string instrument as a means that it determines height of strings and modulates sound by connect strings with the instrument.

The aforesaid bridge must be in an elliptical shape in order for its curved profile not to touch other strings during the performance, thus requiring configuring G string to be higher than E string as for violin and C string higher than A string as for cello.

In addition to that, the bottom of the aforesaid bridge must be accurately adhered to the surface of an instrument, and the position of the bridge must be readjusted once a tuning is made to prevent flexure of the bridge since it is inclined to the direction of base plate during the tuning.

The bridge constructed as above is normally positioned inward from the end of frontal plate with 19.5 cm as for violin, 40˜41.5 cm as for cello and in the median as for F-hole.

Meanwhile, the sound post, though cannot be seen due to its positioning into the chamber, plays a role of directly influencing sound and changing timbre.

Both ends of the sound post must be consistent with the inner curve of an instrument and accurately erected with special care in particular in seasons with heavily fluctuating weather like winter season.

By changing positioning sounds can be modulated either softly or strongly including their balances.

Furthermore, the finger board is structured in a slightly convex form to make sound more strongly and clearly, which shall be afterwards treated smoothly as long-term use may make the surface coarse or buzz to occur due to strings contacted to the base plate which causes inaccurate match of musical tunes.

Moreover, it is desired in general to replace strings every 3˜4 months or if time for exercises is prolonged or when the outer surface of strings is glossy when viewed with naked eyes.

And it is also required to wipe strings in each time of use. If strings are to be replaced, all four strings must be replaced without exception to excellently maintain the acoustic effect of sound.

The internal construction of the aforesaid violin consists of bass-bar and sound post where the former plays a greatly important role in manufacturing violin, being made out of pine to form at least ⅔ of the length of the instrument's main body. This bass-bar must be attached in a slightly oblique manner to the left direction of a frontal plate so that even vibrations are generated broadly over the entire frontal plate.

The round and small bar typed bass-bar made out of pine is positioned in between the frontal plate and the back plate being several millimeters apart from the bridge to its right direction. It acts to convey vibrations in the frontal plate to the back plate inasmuch as the back plate cannot vibrate by itself due to the fact that it is normally made of rigid maple. Two f-shaped holes need to be punched for resonance, being called f-shape holes literally.

As for the bridge, its material, thickness and height are all equally important, where low elevated bridge has a merit that it is easy to press strings, but a demerit that nuisance sound as similar as striking a base plate occurs when strings are sagged due to harsh weather; conversely, it is difficult to play if the elevation is too high.

A neck of the instrument is determined subject to length of a main body of instrument in which too long or short neck may cause the violin player to be confused about the sense of accurate fingering. If thickness of the neck is too shallow or thick, moreover, it becomes hard to adjust notes as accurate as desired or makes a left hand to be easily fatigued.

The back plate normally being made out of maple is generally constructed with two plies of boards by bonding them with glue, but one-ply plate is also available.

The side plate acts to connect the frontal plate and the back plate, being made out of very thin maple wood.

Even the smallest movement with little distinction can make sound of violin varied in a diverse manner.

The guitar is configured as follows; in a broad sense, body, neck and head.

Since the guitar is mostly—exceeding 90%—made of timber, so what kind of timber is used is decisive in fixating its quality, wherein the top component among timber constituting a guitar is deemed most important since it shares the largest part that makes echoing. Nevertheless, the overall quality of the guitar along with its timbre greatly depends or which timber is adopted fit to uniqueness of neck and base plate as well as the aforesaid top board, being also influenced by whether the drying method is natural drying or artificial drying.

Pianos available nowadays are either grand pianos in which strings are placed horizontally or upright pianos in which strings are placed to the vertical direction.

As per the foregoing, the latter is inferior compared with the former in terms of timbre, loudness and sounding mechanism as classified as simplified popular type that is mainly used in home and for exercise.

In the past there was square piano that is table shaped with a rectangular form, but almost disappeared in the late 19th century. Its strings were made of special steel dedicated for those purpose in a way that they were extended with strong tension between hitch pins and the modulated portion, consisting of 1 or 2 strings in the low sound portion and 3 strings in the median and high sound portions as for the 1st sound (i.e. the 1st key).

Vibrations of strings caused by striking of a hammer are transmitted to a soundboard made of shallow timber board via a wooden support to produce sounds. If the player presses a key in the keyboard with the use of a finger, a hammer strikes a string through escapement in which the hammer operates by a lifting hammer (Sachs) in a way that the lever is escaped when the hammer approaches to a string, making the hammer to strike due to inertia. There is additional lever called repetition lever, besides Sachs, in the case of a grand piano, allowing quick and repetitive sounds to produce stably. Upright pianos show instable sounding in quick repetition of sound given no existence of such additional lever. (single escapement)

When the key is struck a hammer, a chain reaction occurs to produce the sound; the key raises the damper. When the key is released, the damper falls back onto the strings, stopping the wire from vibrating with the hammer bouncing from the strings. Therefore, immediately after releasing a finger from a key in the keyboard of piano, sound is no longer generated with the action of a damper; but the sound unless a finger is released from a key continues for a considerably long time in a state of the damper being escaped.

Such mechanism affords generation of a variety of effects uniquely in a piano ranged from staccato with cheerful melody to legato as like as singing a song. There are normally two pedals pressed by a foot in a piano. If the right damper pedal is stepped, the sounding continues even though fingers are released from the keys since all the dampers fall back from strings simultaneously where strings other than those struck by a hammer cause to generate resonance, allowing more affluent sound to produce in view of both sound quality and loudness.

To play the piano greatly relates to the usage of a right pedal, in addition to the method of striking keys. A left pedal called a soft pedal makes loudness to be lowered when pressed. In the case of a grand piano, keys and all in the key-striking device are slightly moved to the right direction when a left pedal is stepped so that only one string among 2 or 3 strings corresponding to each key is kept free from striking by a hammer, which causes changes in both loudness and timbre. As for a upright piano, in contrast with that, the travelling distance of a hammer is shortened since a hammer rail moves so as to reduce the striking speed, resulting in reduction of loudness.

If three pedals are stepped, it causes sound to weaken since a thin felt is inserted between a hammer and strings. This function aims not to improve the performance effect, but eliminate piano pollution incurred during exercises. Contrary to string instruments such as violin, piano is deemed consumable having about 5 year lifecycle as for the purpose of professional performances since the strings are vulnerable to be degraded due to their strong tensions. Moreover, as tunes deteriorate subject to repeated uses, tunings from time to time need to be made according to frequency of uses.

The piano's versatility and ubiquity capable of exhibiting the lowest sound A through thick and long strings to the highest sound C through thin and short strings in the case of a standard piano have made it one of the world's most familiar musical instruments. As such, it can easily express fine changes in dynamic marks from calm pianissimo (very soft) to severe fortissimo (very strong) and allow a multiple of musical notes to play at the same time.

Piano strings these days are made of steel with rigid and good elasticity. There are three strings in each key although only 1 or 2 strings plated with copper are used as per the low sound range. Pitches of sound are determined by their lengths and degree of tensioning.

Whereas strings in the high sound portion are short, those in the low sound portion are longer than approx. 73.5 cm.

Whereas strings as for the grand piano are laid horizontally, those as for the upright piano are vertically erected in consideration of the floor space.

As described above, timber is of importance commonly as for string instruments, guitar and piano. From the past in this regard, only quality of timber itself has been underlined by far, which means that attempts for material based incorporation to strengthen resonance have not yet been concretized.

### SUMMARY OF THE INVENTION

The present invention aims to settle down the aforementioned problems, where the purpose of it lies in providing a method of strengthening resonance of instruments together with the instruments realizable for such purpose in a way that incorporates the mixture of a conductive medium and solid silicone to the interior of the above-defined woodwind instruments so as to achieve to create fine sound by adhesively bonding a pad that are combined to the internal side of a cap holder in such instruments.

The another objective of this invention is to provide a method for strengthening resonance of instruments together with the instruments realizable for such purpose to enable fine sounds to be performed by ways of employing the aforesaid mixture built in the inside of pads that are combined with the cap holder that is facilitated to the interior of said woodwinds.

Another objective involved in this invention is to provide a method for strengthening resonance of instruments together with the instruments realizable for such purpose to enable fine sounds to be nicely performed through the aforesaid conductive medium by ways of filling said mixture between the cap holder acting as a soundboard of said woodwind instrument and said pad.

Another objective involved in this invention is to provide a method for strengthening resonance of instruments together with the instruments realizable for such purpose to enable fine sounds to be nicely performed by ways of employing the aforesaid mixture directly to the inside of the cap holder that plays a role of sounding board in said woodwind instruments through application of said mixture.

Another objective involved in this invention is to provide a method for strengthening resonance of instruments together with the instruments realizable for such purpose to enable fine sounds to be nicely performed by ways of constructing the material of the said conductive medium with at least one or more mixtures of platinum, gold, silver, copper, nickel, bronze and brass.

Another objective involved in this invention is to provide a method for strengthening resonance of instruments together with the instruments realizable for such purpose to enable fine sounds to be nicely performed by ways of the aforementioned technology capable of amplifying existing amplitudes as per the sound of woodwind instruments by partially controlling vibrational intensity depending on the size and type of conductive media.

Another objective involved in this invention is to provide a method for strengthening resonance of instruments together with the instruments realizable for such purpose to enable fine sounds to be nicely performed being capable of offering the echoing phenomenon of sound superbly by ways of adopting a conductive medium to which at least one of platinum, gold, silver, copper, nickel, bronze, brass, phosphor bronze is applied.

Another objective involved in this invention is to provide a method for strengthening resonance of instruments together with the instruments realizable for such purpose to enable fine sounds to be nicely performed, being capable of offering the echoing phenomenon of sound superbly by ways of applying a mixture in which methyl alcohol and adhesive solution are mixed to the spatial portion of said string instruments, guitar and piano that assumes functionality of resonance and amplification of internal acoustic sounds.

Another objective involved in this invention is to provide a method for strengthening resonance of instruments together with the instruments realizable for such purpose to enable fine sounds to be nicely performed in a way that can adhere the compound of said conductive medium unit and silicone or the compound composed of mixture of conductive medium and silicone to the interior of the instrument.

Another objective involved in this invention is to provide a method for strengthening resonance of instruments together with the instruments realizable for such purpose to enable fine sounds to be nicely performed with respect to the instrument that allows the said mixture to be evenly applied in a powder form with nano particles or in a normal powdered form.

Another objective involved in this invention is to provide a method for strengthening resonance of instruments together with the instruments realizable for such purpose to enable fine sounds to be nicely performed with respect to guitar to which said mixture is applied to the inside thereof with an aim to improving resonance generated by the guitar.

Another objective involved in this invention is to provide a method for strengthening resonance of instruments together with the instruments realizable for such purpose to enable fine sounds to be nicely performed with respect to piano to which said mixture is applied to a sounding board thereof with an aim to improving resonance generated by the piano.

Another objective involved in this invention is to provide a method for strengthening resonance of instruments together with the instruments realizable for such purpose to enable fine sounds to be nicely performed with respect to the aforesaid woodwind instruments, string instruments, keyboard instruments and acoustic guitars by ways of incorporating an conductive medium to the internal region functioning in charge of resonance through a few options that are selectively provided with either nano powders, ordinarily fine powders, micro powders shaped in line, plate or other, or solid lump.

Another objective involved in this invention is to provide a method for strengthening resonance of instruments together with the instruments realizable for such purpose to enable fine sounds to be nicely performed by ways of applying, bonding, plating or inputting the metallic unit or compound for the conductive medium to the interior or the exterior of said instruments.

Another objective involved in this invention is to provide a method for strengthening resonance of instruments together with the instruments realizable for such purpose to the extent that can afford the echoing phenomenon nicely by taking advantage of a conductive medium that comprises in its composition at least one of platinum, gold, silver, copper, nickel, bronze, brass, phosphor bronze.

Another objective involved in this invention is to provide a method for strengthening resonance of instruments together with the instruments realizable for such purpose by making use of a mixture in which methyl alcohol and adhesive solution are mixed to the conductive medium.

Another objective involved in this invention is to provide a method for strengthening resonance of instruments together with the instruments realizable for such purpose to enable fine sounds to be nicely performed by ways of the aforementioned technology capable of amplifying existing vibrations as per the sound of said instruments by partially controlling vibrational intensity depending on the size and type of conductive media.

The objective relating to the aforementioned current invention is accomplished by the method of intensifying resonance of musical instruments, more particularly, as a means of strengthening resonance with respect to said woodwinds in which cap holders are formed to the inside thereof and pads are combined with the said cap holders, being featured by inclusively comprising: an agitation step for agitating a mixture of a conductive medium that contains at least one of platinum, gold, silver, copper, nickel, bronze, brass, phosphor bronze with solid silicon; a mixture heating step for heating the agitated mixture; a coagulation step for naturally cooling the heated mixture and coagulating it into a solid; a mixture pulverization step for pulverizing the mixture; a mixture application step for applying the mixture to the inside of the cap holder; and a pad attaching step for attaching a pad to the interior of the cap holder after the mixture application step.

According to the present invention, it is featured, following the said pulverization step of the mixture, by additionally including a plating step whereby the interior of the said cap holder is applied by the mixture that contains one or more of platinum, gold, silver, copper, nickel, bronze, brass and phosphor bronze.

The objective relating to the aforementioned current invention is accomplished by the method of strengthening resonance of musical instruments, more particularly, as a means of intensifying resonance with respect to said woodwinds in which a cap holder is formed to the inside thereof and a pad is combined with the said cap holder, being featured by inclusively comprising: an agitation step for agitating a mixture of a conductive medium that contains at least one of platinum, gold, silver, copper, nickel, bronze, brass, phosphor bronze with solid silicon; a mixture heating step for heating the agitated mixture; a coagulation step for naturally cooling the heated mixture and coagulating it into a solid; a mixture pulverization step for pulverizing the mixture; a pad mixture application step for applying the mixture to the oppositely acoustic region of pad that corresponds to the said cap holder; and a pad attaching step for attaching a pad to which said mixture has been applied to the interior of said cap holder.

The objective relating to the aforesaid current invention is accomplished by the method of strengthening resonance of musical instruments, being featured by sequentially providing steps comprising: a step of forming a mixture in which methyl alcohol, powder for the conductive medium and adhesive solution are mixed; a mixture applying step whereby said mixture formed as above is sprayed to the inside of an instrument; and a rapidly cooling step whereby said mixture applied to said instrument is quickly dried by pressurizing air with the use of an air compressor.

The objective relating to the aforesaid current invention is accomplished by the method of strengthening resonance of musical instruments, being featured by mounting a metallic unit for the conductive medium or a metallic mixture for the conductive medium to the interior of said instrument under the condition that said instrument indicates any of string instruments, piano, brass instruments and woodwind instruments made out of wood in an electrically insulating state.

The objective relating to the aforesaid current invention is accomplished by the method of strengthening resonance of musical instruments, being featured as per the said instrument by making dried after having applied a metallic unit for the conductive medium or a metallic mixture for the conductive medium to a soundbox in the interior of the string instruments made out of wood, a soundboard of the piano and a top board of the traditional musical instruments.

The objective relating to the aforesaid current invention is accomplished by the method of strengthening resonance of musical instruments, being featured by additionally mounting a metallic unit for the conductive medium or a metallic mixture for the conductive medium with the use of an adhesive along with the interior or exterior surface of said instruments under the condition that said instruments indicate string instruments, woodwinds, brass instruments, piano and Korean traditional instruments.

The objective relating to the aforesaid current invention is accomplished by the method of strengthening resonance of musical instruments wherein such instruments are constructed by any of brass instruments, saxophones and flutes, being featured by making a metallic unit for the conductive medium or a metallic mixture for the conductive medium applied or attached along with the interior surface of said instrument as well as plating the portion in which vibrations are weak in multiple layers to intensify such vibrations.

The objective relating to the aforesaid current invention is accomplished by the method of strengthening resonance of musical instruments, being featured by applying or attaching a compound of an unit for the conductive medium and silicone, or a compound of a mixture for the conductive medium and silicone to the interior of said instruments.

The objective relating to the aforesaid current invention is accomplished by the method of strengthening resonance of musical instruments, being featured by plating after applying or attaching a compound of an unit for the conductive medium and silicone, or a compound of a mixture for the conductive medium and silicone to the interior of said instruments.

According to the present invention, the metallic unit for the said conductive medium is featured by containing at least any one of platinum, gold, silver, copper, nickel, bronze, brass and phosphor bronze.

According to the present invention, it is featured by producing a mixture by way of containing one or more of methyl alcohol, adhesive solution, silicone and glue in the aforesaid metallic unit of the conductive medium and the metallic mixture of the conductive medium.

According to the present invention, the metallic unit of said conductive medium incorporated to intensify vibrations for said instruments is featured by mixing metallic powders composed of either platinum, gold, silver, copper, nickel, bronze, brass or phosphor bronze with either silicone, glue, bond or adhesive to produce the conductive medium in liquid phase or a solid form.

According to the present invention, the metallic unit of said conductive medium incorporated to intensify vibrations for said instruments is featured by mixing metallic wires, plates and the conductive medium in a lump shape that are composed of either platinum, gold, silver, copper, nickel, bronze, brass or phosphor bronze with either silicone, glue, bond or adhesive to produce the conductive medium in liquid phase or solid form.

According to the present invention, the metallic unit of said conductive medium and the metallic mixture of said conductive medium are featured by being selected in any one of nano-scaled powder, ordinarily fine powder, very fine power in a form of line, plate or other versatile form or solid lump in a bar shape.

According to the present invention, the aforesaid plating method is featured, although being limited to be applied as a partial plating to the portion in which vibrations are weak in the inside of said instruments, with the multilayered mixed plating wherein such partial plating is carried out to form multiple layers with the use of the metallic unit for the conductive medium that contains any one or more of platinum, gold, silver, copper, nickel, bronze, brass and phosphor bronze.

The objective relating to the aforesaid current invention, with regard to woodwind instruments designed to intensify resonance by making pads combined to the interior of said instruments, is accomplished through resonance-intensified instruments being featured by forming multiple number of cap holders that support said pads so that such multiplied pads are combined in the interior of said woodwinds and making these pads combined to the inward direction of said cap holders, wherein a conductive medium structured as a mixture that contains one or more of platinum, gold, silver, copper, nickel, bronze, brass and phosphor bronze is combined between said cap holders and pads.

According to the present invention, it is featured by plating a mixture that contains between said cap holders and pads one or more of platinum, gold, silver, copper, nickel, bronze, brass and phosphor bronze to the interior of cap holders.

The objective relating to the aforesaid current invention, with respect to said instruments in which frontal plate and rear plate are connected through side plate in a way that the spatial portion can be formed to the interior part of said instruments, is accomplished through resonance-intensified instruments as string instruments being featured by applying a mixture in the powdered shape with nano particles mixed by both methyl alcohol and adhesive solution to the conductive medium structured by any one of platinum, gold, silver, copper, nickel, bronze, brass and phosphor bronze in one or more plates among frontal plate, rear plate and side plate within the said instruments.

According to the present invention, the aforesaid string instruments are featured by forming any one of violin, cello, viola, double bass and acoustic guitar whose profiles are made out of wood.

According to the present invention, the aforesaid string instruments are featured by making the metallic unit for the conductive medium or the metallic mixture for the conductive medium formed to sound post, base bar and end pins thereof.

The objective relating to the aforesaid current invention, with respect to said instruments in which a soundboard is configured in one side thereof to their inward direction so that the spatial portion can be formed, is accomplished through resonance-intensified instruments as pianos being featured by applying a mixture in the powdered shape with nano particles mixed by both methyl alcohol and adhesive solution to the conductive medium structured by any one of platinum, gold, silver, copper, nickel, bronze, brass and phosphor bronze to the inside of the soundboard of the said instruments.

According to the present invention, the aforesaid pianos are featured by being made out of wood in an acoustic shape.

The objective relating to the aforesaid current invention is accomplished through resonance-intensified instruments as string instruments being featured by applying the conductive medium to sound post that transmits vibrations of string supports to the rear plate, and base bar facilitated in the rear part of the frontal plate that transmits vibrations over to the entire area of that frontal plate.

The objective relating to the aforesaid current invention is accomplished through resonance-intensified instruments as one of string instruments, acoustic guitars, alto saxophones and tenor saxophones, being featured by mounting a metallic unit for the conductive medium or a metallic mixture for the conductive medium to the interior of said instruments.

The objective relating to the aforesaid current invention is accomplished through resonance-intensified instruments as one of string instruments, woodwinds, brass instruments and Korean traditional instruments, being featured by making them dried after having applied a metallic unit for the conductive medium or a metallic mixture for the conductive medium along with the interior surface of said instruments.

The objective relating to the aforesaid current invention is accomplished through resonance-intensified instruments as one of string instruments, woodwinds, brass instruments, acoustic guitars and pianos, being featured by attaching a metallic unit for the conductive medium or a metallic mixture for the conductive medium along with the interior or exterior surface of said instruments.

The objective relating to the aforesaid current invention is accomplished through resonance-intensified instruments as brass instruments, being featured by additionally treating partial plating in multiple layers after having attached a metallic unit for the conductive medium to the area that exhibits weak vibrations along with the interior surface of said instruments to intensify such vibrations.

The objective relating to the aforesaid current invention is accomplished through resonance-intensified instruments as pianos, being featured by applying a metallic unit for the conductive medium or a metallic mixture for the conductive medium to a soundboard of said instruments.

The objective relating to the aforesaid current invention, where the said instruments are woodwind instruments designed to make cap holders and pads combined to the interior of said instruments, is accomplished through resonance-intensified instruments being featured by forming a metallic unit for the conductive medium or a metallic mixture for the conductive medium between said cap holders and said pads so that such multiplied pads are combined in the interior of said woodwinds.

The objective relating to the aforesaid current invention is accomplished through resonance-intensified instruments, being featured by plating after having applied or attached a compound of an unit for the conductive medium and silicone, or a compound of a mixture for the conductive medium and silicone to the interior of said instruments.

According to the current invention pertaining to a method for intensifying resonance of musical instruments including the instruments realizable for such invention, this invention nicely provides resonance for woodwind instruments enabling the user to more easily practice them, and further offers a wide spectrum of effects and representations, by way of using said woodwinds to which this invention is incorporated, such as various and uniquely beautiful timbre, rich loudness, dynamic performances of pitches and tones in a manner of making soft sound softer and strong sound stronger and expressions of time value having good reverberation.

In other words, by raising strength of vibrations from the stage in which sound starts to produce, this invention provides the effect to enhance periodicity of vibrations in a repetitive fashion.

Moreover, by way of applying a mixture inclusive of the conductive medium as stressed above to the inside of woodwind instruments, it is highly expected to basically manufacture the instrument having good sound quality, providing the effect effectuating even a low-priced instrument to be played to produce the sound seemingly affordable by a high-priced instrument, in addition to the effect that creates sounds with a variety of styles depending on the type of aforesaid conductive media.

For example, if gold plated as a conductive medium, the sound tinted with heavy but sincere tone is producible; likewise, cheerful and soft tone of sound in the case of silver, and soft and affluent tone of sound in the case of nickel, accordingly rendering versatility for a musician to play with unique and highly individual style of sounds.

By providing better resonance for string instruments, guitars and pianos, the player or the user is able enjoyably to practice or play pieces of music in an easier manner.

By taking the fullest advantage of this novel invention as addressed above by each characteristic, it is achievable to reproduce the sound worthy of being producible by an exquisite instrument or even create the sound beyond such exquisite instrument.

On the other hand, this novel invention further provides a method capable of partially modulating vibration intensity by varying the volume and type of said conductive medium, in turn making sound quality adjustable part by part as desired, being thus exemplified that, by utilizing this inventive technology, existing pulses of sound where intended can be amplified or intensified. In addition, this novel invention leads to manufacture of a masterpiece instrument having the good echoing effect in a refreshed sense by extending the time the sound continues to vibrate and controlling the echoing time for bettering the echoing effect.

By applying the conductive medium to the interior or exterior of the instruments aimed to provide resonance for them more excellently, this invention offers various features enabling the user to more easily practice the instruments, and further provides a wide spectrum of effects and representations, by way of using the instruments to which this invention is incorporated, such as various and uniquely beautiful timbre, rich loudness, dynamic performances of pitches and tones in a manner of making soft sound softer and strong sound stronger and expressions of time value having good reverberation.

In particular, this novel invention delivers fine reverberation during the performance of music, which not only makes crossover of musical tone to tone softer and more natural, but provides the sense of symmetrical balance and stability in expressions of low, middle and high sounds, further allowing to perform, subject to the type of said conductive medium, various sounds in a feeling of either compressive, cozy and warm sound, cool and sincere sound, or light and sincere sound, and in such manner providing the effect for enjoying affluent flavors of pure, clear and clean sounds.

Moreover, by way of applying an unit for the conductive medium or a metallic mixture inclusive of the conductive medium as stressed above to the inside or the outside of musical instruments, it is highly expected to basically manufacture the instrument having good sound quality, providing the effect effectuating even a low-priced instrument to be played to produce the sound seemingly affordable by a high-priced instrument, in addition to the effect that creates sounds with a variety of styles depending on the type of said conductive media.

### BRIEF DESCRIPTION OF THE DRAWINGS

FIG. 1 is a block diagram according to the embodiment of the present invention.

FIG. 2 is an oblique view according to the embodiment of the present invention.

FIG. 3 is a cross sectional view showing the state where a mixture is applied to the inside of cap holders of the present invention.

FIG. 4 is a drawing according to another embodiment of FIG. 3.

FIG. 5 is a drawing according to additionally other embodiment of FIG. 3.

FIG. 6 is an oblique view of violin according to the embodiment of the present invention.

FIG. 7 is an exploded oblique view of FIG. 6.

FIG. 8 is another oblique view according to the embodiment of the present invention.

FIG. 9 is an oblique view of piano that can be carried out in a way identical to the present invention.

FIG. 10 is an oblique view according to another embodiment of the present invention.

FIG. 11 is a cross sectional view showing the state where a conductive medium is input according to the embodiment of the present invention.

FIG. 12 is a cross sectional view showing the state where a conductive medium is applied according to the embodiment of the present invention.

FIG. 13 is a cross sectional view showing the state where a conductive medium is attached according to the embodiment of the present invention.

FIG. 14 is a block diagram showing the state where a conductive medium is provided to the interior of an instrument according to the embodiment of the present invention.

FIG. 15 is an exemplary drawing analyzing the sounds before and after the application of resonance-intensifying work for violins according to the embodiment of the present invention.

FIG. 16 is an exemplary drawing analyzing the sounds before and after the application of resonance-intensifying work for saxophones according to the embodiment of the present invention.

### DESCRIPTION OF THE INVENTION

Terms and words that have been used as to and as for the present descriptions and scope of claims shall not be interpreted being limited to customary or literal meanings as they are, but rather construed as meanings and concepts consistent with the technological ideas and thought of the present invention under the groundings that an inventor is entrusted to define terms and words where or as appropriate for its own in order to describe his or her invention(s) with the best illustrative ways.

Therefore, the embodiments as denoted in the present descriptions as well as the constructions as illustrated in the drawings merely account for the most preferred embodiments in connection with the present invention, in no case representing all technological ideas of the present invention, so it shall be understood that, at the time of the application of this invention, there may be a variety of modifications and equivalent arrangements replaceable for what are claimed herein.

Hereunder is the detailed description on preferred embodiments of the present invention with reference to the drawings attached herewith.

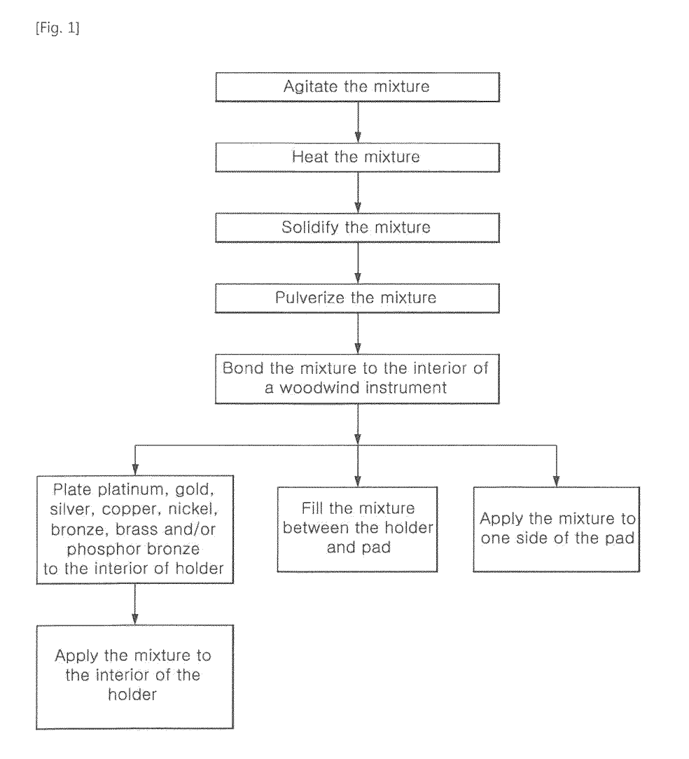

FIG. 1 is a block diagram according to the embodiment of the present invention, as illustrated above, comprising: an agitation step for agitating a mixture (12) of a conductive medium (121) with solid silicone (122); a mixture (12) heating step for heating the agitated mixture (12) at temperature of 80 C for about 10˜15 minutes; a coagulation step for naturally cooling the heated mixture (12) and coagulating into a solid; a mixture pulverization step for pulverizing the said mixture (12); a mixture application step for applying the said mixture (12) to the inside of the said woodwind instrument (A).

The mixture application step as above for applying aforesaid mixture (12) to the inside of the aforesaid woodwind instrument (A) can be carried out through the method comprising: a mixture (12) mounting step for mounting the aforesaid pulverized mixture (12) to the inside of pads (11); a mixture (12) filling step for filling. the aforesaid pulverized mixture (12) between pads (11) and cap holders (10) that support said pads (11); a mixture (12) application step for evenly applying the aforesaid pulverized mixture (12) to one side of the back surface of pads positioned in the inside of the woodwind instrument (A).

By doing so, said mixture (12) combined of said conductive medium (121) with said solid silicone (122) can be tightly bonded with the said woodwind instrument (A).

With the help of a mixture (12) applied to cap holders and pads in the interior of the woodwind instrument (A) as described above, it can be carried out for optimum sound projection via resonators of said woodwind instrument (A).

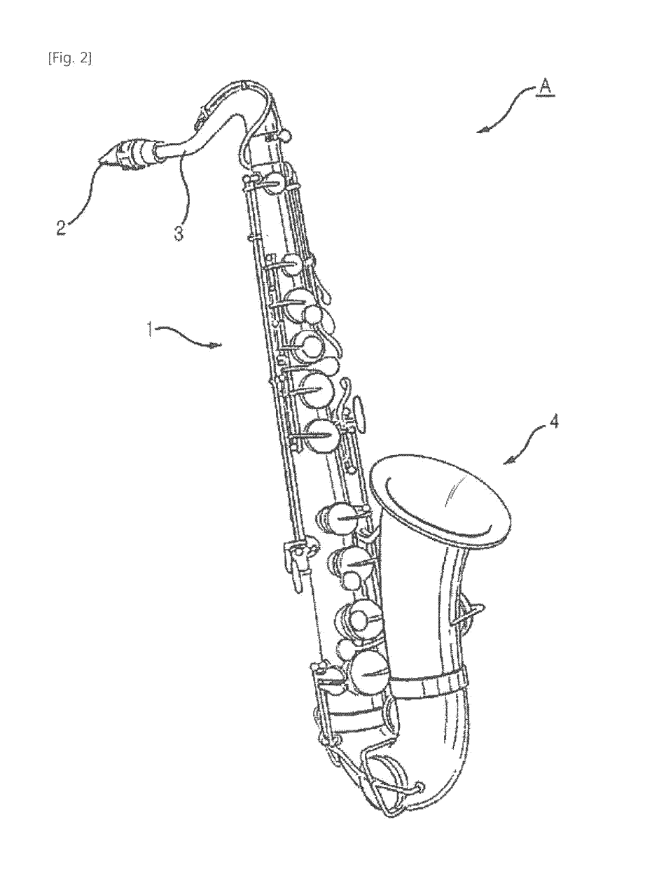

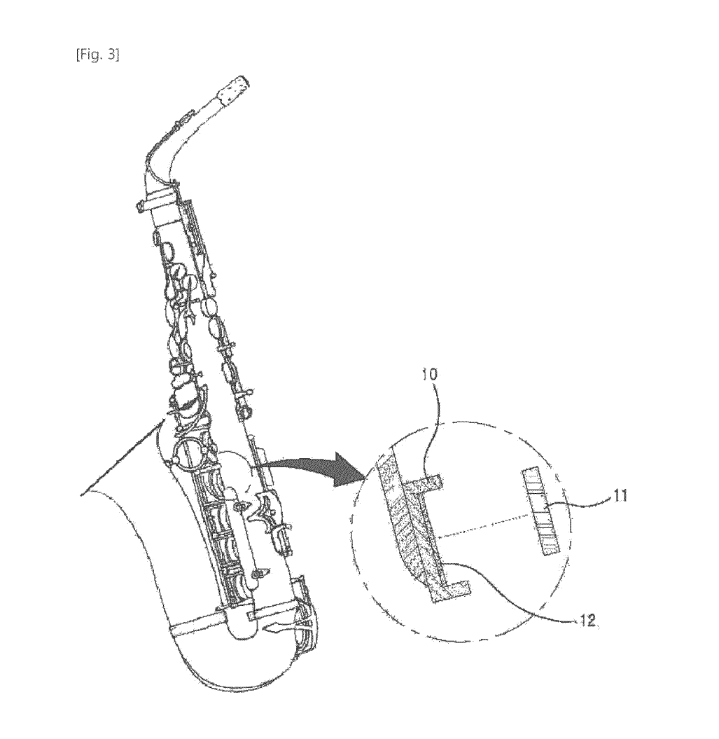

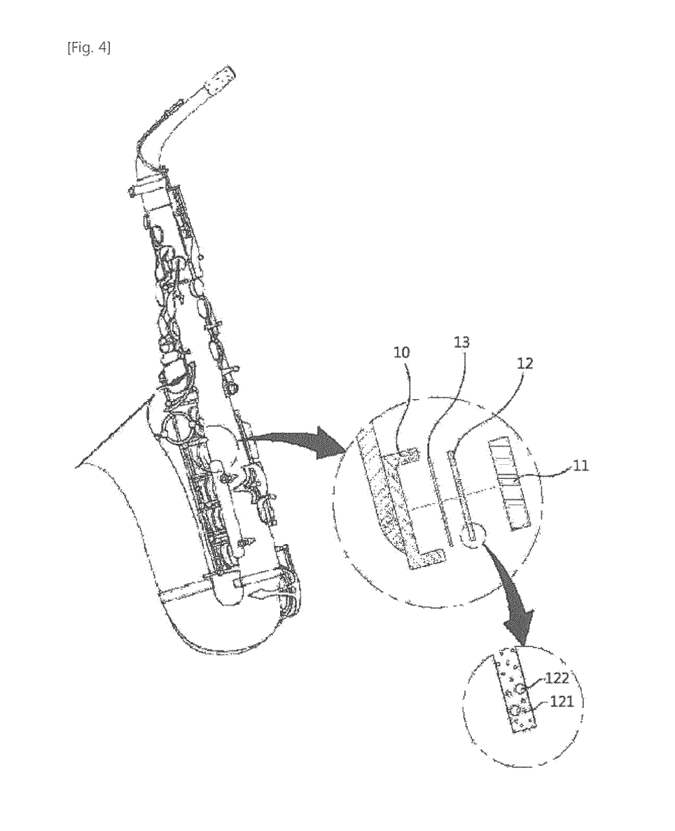

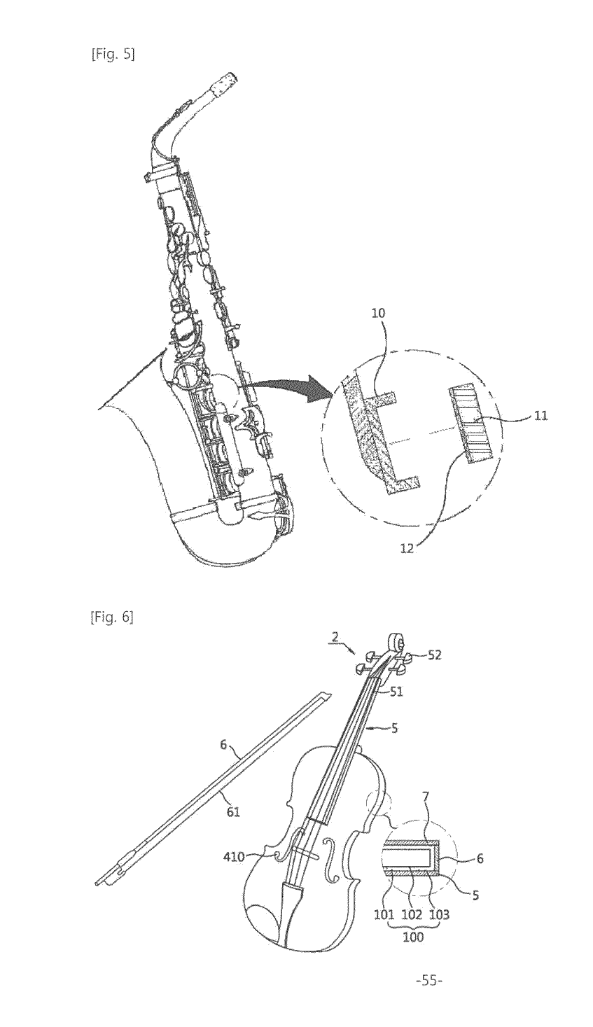

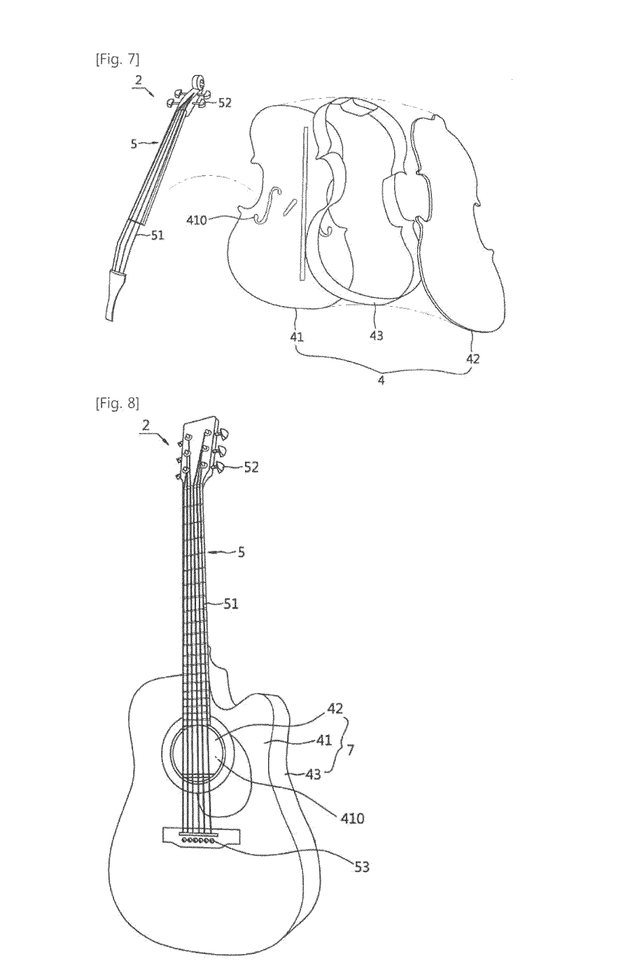

FIG. 2 is an oblique view according to the embodiment of the present invention, wherein high-, middle- and low-octave keys are formed, as illustrated above, in order to modulate each key balance.

The saxophone as constructed above has a structure in which a neck (3) is formed in a rounded shape to one side of the top main body (1) while a mouthpiece (2) is formed to the tip of said neck (3).

Moreover, an upturn played bell (4) is formed to the outer direction of the bottom of the main body (1) so that the sound transmitted through said mouthpiece (2) is externally flown out via this upturn played bell (4).

In addition to that, there are a plurality of metal tubes and tone holes along the median part of the main body (1) of the saxophone so as to modulate the acoustic effect variably.

FIG. 3 is a cross sectional view showing the state where a mixture (12) is applied to the inside of cap holders. (10) according to the embodiment of the present invention, wherein pads (11) as illustrated above are combined with cap holders (10) as shown in an enlarged, view to one side of the saxophone.

Said pads (11) as combined as above are formed to have specific thicknesses.

In order that pads (11) as combined above are to combine with cap holders (10), it is constructed so that a mixture (12) in which a conductive medium (121) and solid silicone (122) are mixed is built in the interior of said cap holders (10).

As to the conductive medium (121) as constructed above, it is possible to use by containing any one or more of platinum, gold, silver, copper, nickel, bronze, brass and phosphor bronze.

In order that resonance of the sound transmitted through the said mouthpiece (2) is raised at maximum, it is constructed so that the conductive medium (121) as constructed above is applied and filled between said cap holders (10) and pads (11).

FIG. 4 is a drawing illustrating the embodiment of the present invention, wherein pads (11) as illustrated above are combined with cap holders (10) as shown in an enlarged view to one side of the saxophone.

As to pads (11) and cap holders (10) as combined above, to begin with, plating of a mixture (13) that contains any one or more of platinum, gold, silver, copper, nickel, bronze, brass and phosphor bronze is made uniformly to the inside of cap holders (10).

In order that, after performing the plating as above, a mixture (12) is filled so as to have a specific thickness, it can be carried out to bond said mixture (12) through a replaced method other than the conventional use of glue to bond it with said pads (11) and cap holders (10).

In other words, by ways of filling a mixture (12) in between said cap holders (10) and pads (11) after plating additives (13) composed as above of any one or more of platinum, gold, silver, copper, nickel, bronze, brass and phosphor bronze, fixing strength of said pads (11) is improved, and, moreover, it is constructed so that resonance of the sound transmitted through said mouthpiece (2) can be maximally raised by applying a conductive medium (121) included to said mixture (12), i.e. the conductive medium (121) mixed to contain any one or more of platinum, gold, silver, copper, nickel, bronze, brass and phosphor bronze.

Meanwhile, a compound of the unit of conductive medium and silicone or a compound of the mixture of conductive medium and silicone is allowed to attach to the inside of the instrument.

In addition, there are alternatives to mount a metallic unit for the conductive medium or a metallic mixture for the conductive medium to the interior of string instruments, pianos, brass instruments and woodwind instruments framed with the use of wood in an electrically insulating state, or to make dried after applying a metallic unit for the conductive medium or a metallic mixture for the conductive medium to the echoing chamber of string instruments, the soundboard of pianos and the top plate of Korean traditional instruments framed with the use of wood in an electrically insulating state

And, a metallic unit for the conductive medium or a metallic mixture for the conductive medium can be more attached along the internal or external surface of string instruments, pianos, brass instruments and woodwind instruments with the use of adhesives.

The application method applied to a soundboard of the piano can be similarly used for elements of the internal configuration.

By controlling intensity of vibrations subject to the volume of the conductive medium, it is possible to flexibly to modulate magnitude of loudness and sound continuing time as for sound quality of an instrument—more particularly, those factors such as magnitude of loudness and sound continuing time can be freely adjustable by varying the volume of the conductive medium, thus changing quality of sound as desired when manufacturing an instrument.

The magnitude of loudness and sound continuing time as for an instrument are controllable in a non-electrical natural state such as an electrical effect system, which leads to capability to basically improve sound quality of an instrument.

This novel invention makes it possible to settle down various problems associated with sound quality as per conventional instruments available on sale, even mitigating such specifically partial problems, such as the instrument with lack of loudness or with no echoing, or problematic expressions of musical notes given unclear timbre and width of the instrument, by minutely applying the conductive medium with an appropriate volume, particularly to the area in which weak vibrations are exerted.

The conductive medium is used either in a form of nano-size particles independently or in a combination of nano particles, powder or other various types, without the use of adhesive or by mixing a substance acting as adhesive such as glue or silicone.

Once the conductive medium is applied, the finishing may be made by using varnish or paint, or, where necessary, by mixing the conductive medium with varnish or paint for use.

FIG. 5 is a drawing illustrating additionally other embodiment of the present invention, wherein, prior to combining pads (11) in charge of resonators with cap holders (10) as illustrated above, it is constructed so that said cap holders (10) are combined to the inside of an instrument in a state that, as shown above, a mixture (12) is applied to the region in which pads (11) are combined with cap holders (10).

It is constructed, by directly applying the mixture (12) as used for the aforesaid purpose to the inside of the portion that acts as a soundboard of woodwind instruments (A) including saxophones, so that resonance of the woodwind instruments (A) is raised to the highest extent enabling to produce elegant and beautiful sounds.

FIG. 6 is an oblique view of the violin (2) according to the embodiment of the present invention and FIG. 7 is an exploded oblique view of FIG. 6, wherein said violin (2) is constructed as illustrated above with the body portion (7) in which a frontal plate (41) is combined with a rear plate (42) through a side plate (43) together with a finger board (5) located in said frontal plate (41) of said body portion (7).

In a more detailed manner, the finger board (5) as illustrated on the top of the body portion (4) in which the spatial portion exists to the inward direction as above is formed to the longitudinal direction, wherein a neck is formed to one side of the said longitudinal direction and pegs (52) are formed in the outer part of the said neck.

Strings (51) are constructed to be connected with the front part of the finger board (5) as formed above so that the sound is modulated through said pegs (52).

As to the construction by this invention in which a bow (6) is formed in the frontal part in order that sounds are produced by using strings (51) as above, various sounds are producible as there forms horse tail (61) along the longitudinal direction of said bow (6) in a way that said horse tail (61) contacts with said strings (51) in a state that the player grabs a knob that is formed in one side of said bow (6).

In addition to that, sound holes are formed in the internal region of said frontal plate (41) through which the sound echoed and propagated from the internal space of said body portion (7) is emitted out externally.

An enlarged view as illustrated in one side of the above is made to represent the mixture (12) that is applied to the interior of said body portion (70 in a more detailed way, where the said mixture (12) is applied to the frontal plate (41), the rear plate (42) and the side plate (43) of the said body portion (7).

In other words, the mixture (12) is applied to the interior region of the frontal plate (41), the rear plate (42) and the side plate (43) of the said body portion (7) that is deployed as above, where the said mixture (12) is desired to be constructed by mixing a conductive medium (121), methyl alcohol (102) and adhesive (103).

The conductive medium (121) of the mixture (12) as structured above can be used by selecting and mixing any one of platinum, gold, silver, copper, nickel, bronze, brass and phosphor bronze, or two or more of them if required.

FIG. 8 is another oblique view of the guitar (2′) according to the embodiment of the present invention, wherein, as illustrated above, the said guitar (2′) is also constructed so that the body portion (7) consists of the frontal plate (41), the rear plate (42) and the side plate (43) in which the finger board (5) is combined to the top part of said body portion (7).

The body portion (7) as constructed above has sound holes (410′) formed in the interior of its central part, while a plurality of bridges (53) are formed to the bottom of said body portion (7) in which strings of guitar (51) are connected with said bridges (53).

In order that strings (51) as constructed above are connected tightly with tension, the neck and head are sequentially formed to the end part of said finger board (5) where a plurality of pegs (52) are arranged to the outer part of said head.

By modulating strings (51) through pegs (52) as arranged above, performing music with wider range of sounds is possible from the said guitar (2).

Meanwhile, an enlarged view as illustrated in one side of the aforesaid drawing has the same configuration with that as illustrated for the aforesaid violin (2), wherein it is also desired to construct a conductive medium (121) applicable to the interior of the body portion (7) by containing any one, or two or more if necessary, of platinum, gold, silver, copper, nickel, bronze, brass and phosphor bronze.

As to the preferred embodiment of the present invention, it also possibly constructs the conductive medium (121) as structured above to be directly applied to the internal part of said body portion (7), or construct the mixture (12) mixed with said conductive medium (121), methyl alcohol (102) and adhesive solution (103) for the sake of better improved effect of adhesion.

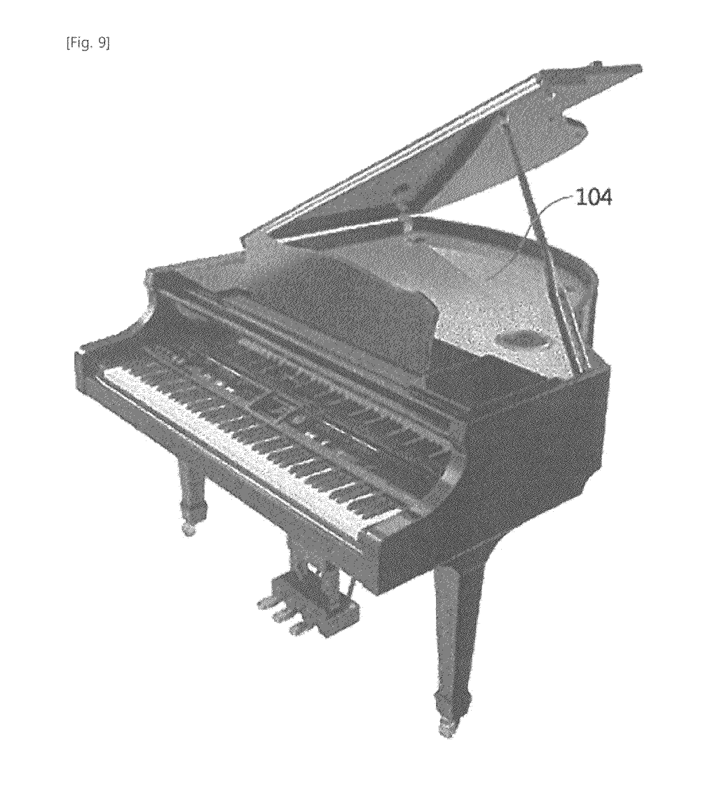

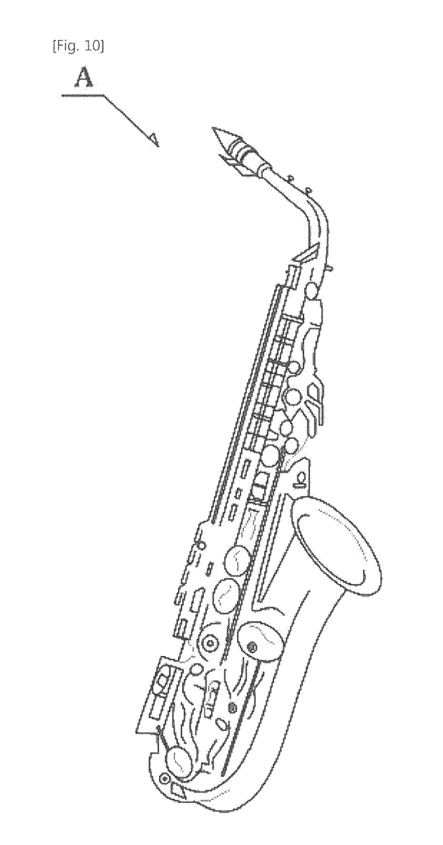

FIG. 9 is an oblique view of the piano according to the embodiment of the present invention, which demonstrates that, in playing the keyboard of the piano, this novel invention can be identically utilized as illustrated above, enabling to perform various sounds with highly clear and enhanced sounding quality through a soundboard (104).

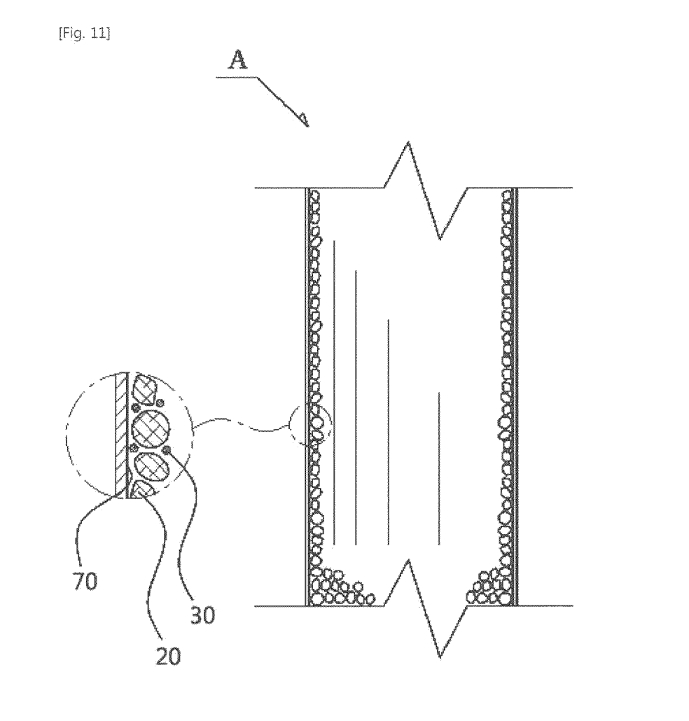

FIG. 10 is an oblique view according to another embodiment of the present invention, which takes the saxophone as an example among various instruments (B) provided according to the present invention as illustrated above, wherein a metallic unit (20) for the conductive medium or a metallic mixture (30) for the conductive medium is provided to the interior of the saxophone as illustrated above.

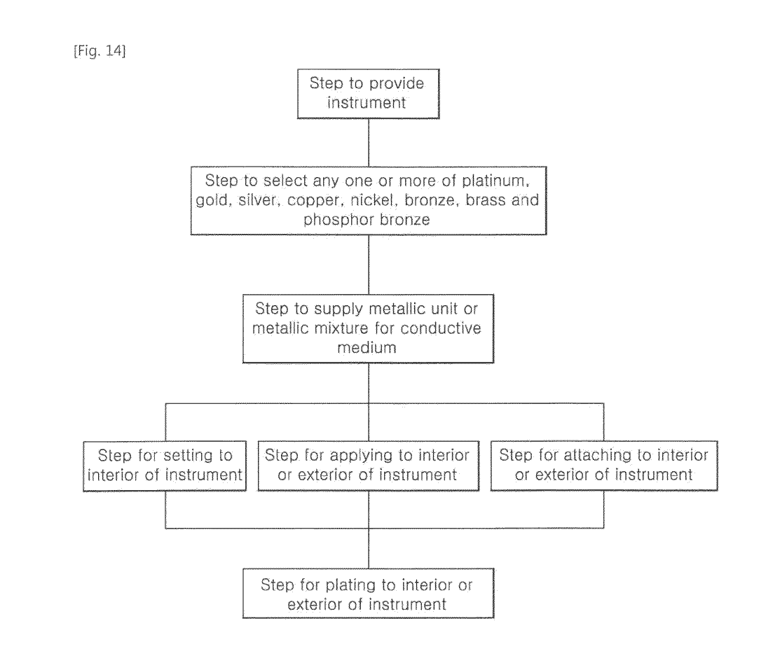

The method for providing the metallic unit (20) for the conductive medium or the metallic mixture (30) for the conductive medium to the said instrument (B) is made by adopting one as illustrated by either FIG. 11 or FIG. 13.

In other words, FIG. 11 is a cross sectional view showing the state where the metallic unit (20) for the conductive medium or the metallic mixture (30) for the conductive medium is mounted according to the embodiment of the present invention; more specifically, the metallic unit (20) for the conductive medium or the metallic mixture (30) for the conductive medium is not fixedly attached to the interior of said instrument (B), but the metallic unit (20) for the conductive medium or the metallic mixture (30) for the conductive medium is mounted to the interior of said instrument (B) in the form of granules or fine particles.

In the case as above where the metallic unit (20) for the conductive medium or the metallic mixture (30) for the conductive medium is mounted, it is also possible to nicely exhibit resonance of sounds generated by the said instruments (B).

In the case as above of being provided in the form of granules or fine particles, there may probably cause the difference in the sound range subject to where they are positioned; however, realistic resonance of sounds herein is constructed to be superior than that of ordinary instruments (B) by making the conductive medium to be practically evenly distributed over the internal surface of the said instruments (B).

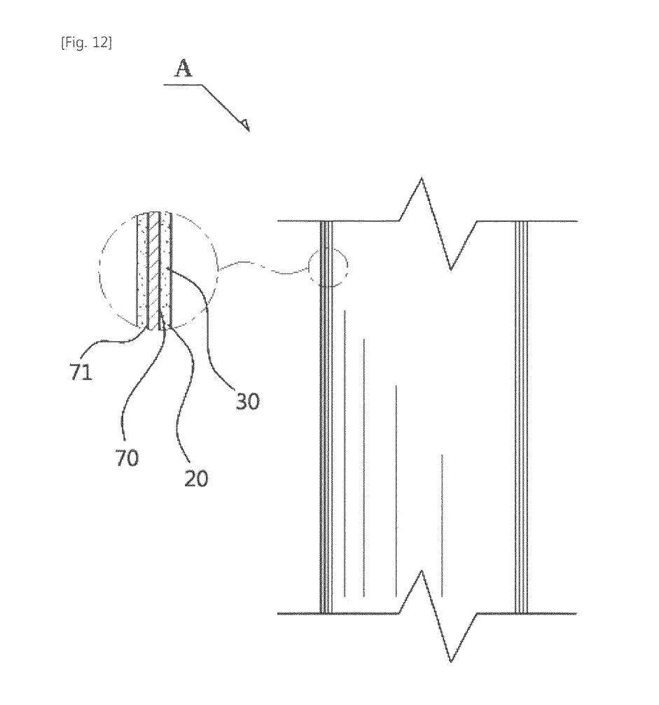

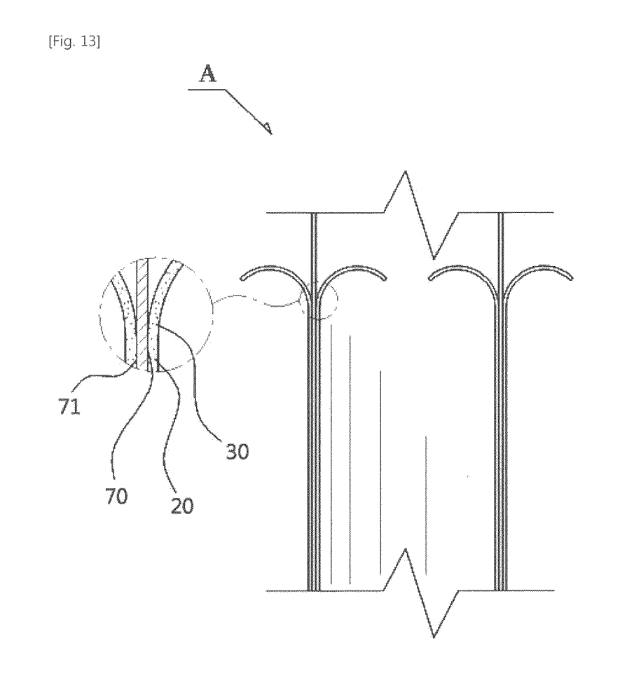

FIG. 12 is a cross sectional view showing the state where the metallic unit (20) for the conductive medium or the metallic mixture (30) for the conductive medium is applied or plated according to the embodiment of the present invention, while FIG. 13 is a cross sectional view showing the state where the metallic unit (20) for the conductive medium or the metallic mixture (30) for the conductive medium is attached according to the embodiment of the present invention, where the metallic unit (20) for the conductive medium or the metallic mixture (30) for the conductive medium is designed to be regularly distributed over the entire interior (70) or exterior (71) surface of the said instruments (B) so as to be the fittest for intensifying resonance of sounds, in an attempt to apply or attach the metallic unit (20) for the conductive medium or the metallic mixture (30) for the conductive medium along the interior (70) or exterior (71) surface of the said instruments (B).

In particular, in the case in which, as illustrated in an enlarged view in one side of FIG. 13, the metallic unit (20) for the conductive medium or the metallic mixture (30) for the conductive medium is bonded through an appropriate adhering means along the entire interior (70) or exterior (71) surface of the said instruments (B), such means to bond each other can be easily and equally applicable for the instruments (B) available in the past, leading to multipurpose utilization.

FIG. 14 is a block diagram showing the state where a conductive medium is provided to the interior of the instruments (B) according to the embodiment of the present invention, wherein the metallic unit (20) for the conductive medium or the metallic mixture (30) for the conductive medium similarly as above is provided to the said instruments (B) that are basically given, in which case, however, the metallic unit (20) for the conductive medium or the metallic mixture (30) for the conductive, medium is constructed to contain any one or more of platinum, gold, silver, copper, nickel, bronze, brass and phosphor bronze.

In order that the metallic unit (20) for the single conductive medium composed of each metallic compositional element as above or the metallic mixture (30) for the conductive media composed of a plurality of metallic compositional elements is provided to the instruments (B), the method to construct can be carried out separately by either mounting, applying, attaching or plating the said metallic unit (20) for the conductive medium or the metallic mixture (21) for the conductive medium to the interior (70) or exterior (71) surface of the instruments (B).

It is clearly apparent that the scope of the present invention shall be extended to those that can be carried out originated from this invention, such as the one using a metallic component or any else metallic substance other than metallic component(s) that are incorporated herein to the metallic unit (20) for the conductive medium or the metallic mixture (30) for the conductive medium being provided in order to strengthen resonance of the instruments (B) as above, as well as the one adopting the way hereof that provides, as described above, the metallic unit (20) for the conductive medium or the metallic mixture (30) for the conductive medium to the instruments (B) or any feasible else way attachable to the instruments (B).

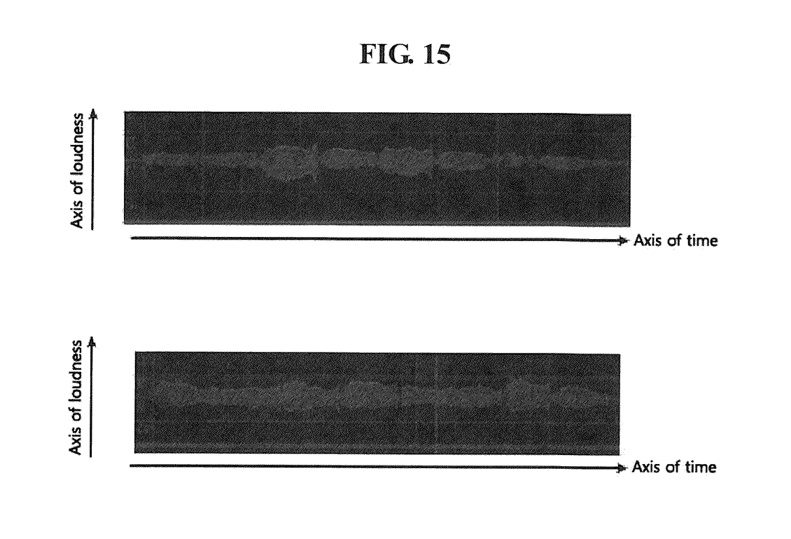

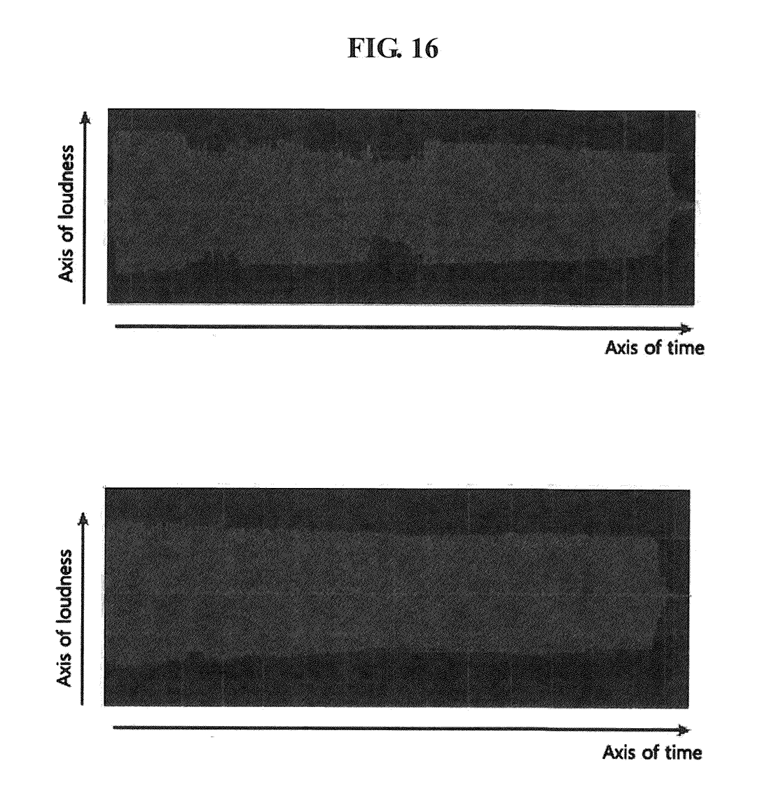

FIG. 15 and FIG. 16 are exemplary drawings analyzing the sounds before and after the application of resonance-intensifying work for violins and saxophones, respectively, where the upper illustrations as illustrated above are the drawings prior to the work revealing lack of loudness, irregular loudness and inconsistent balance in terms of low-, middle- and high-octave sounds.

Furthermore, it is found that reverberation is small, width of sound is narrow, and the dynamic range enabling to produce from soft sound to strong sound is narrowly formed.

What is worse, besides, is the disadvantage causing sound quality imbalanced though admitting that the certain range of sound either in low-, middle- and high-octave sounds is well exhibited, including coarse, non-soft and noisy characteristics of sounds with low volume of loudness.

In consequence, it is hard to produce the specific portion of sound amongst the broad range of low-, middle- and high-octave sounds due to shortcomings incapable of responding what the player is intended with inaccurate sounds, including poor reverberation making it difficult to breathe and express emotions.

Contrary to those as above, the drawings illustrated at the lower parts pertain to the post-work analyses, evidencing that the dynamic range is expanded from very soft sound up to very powerful and strong sound, that sound quality becomes regular and stable by getting out of irregularity, and that sound quality gets into broadly balanced harmony over the range of low-, middle- and high-octave sounds.

1-31. (canceled)

32. Method for intensifying resonance of musical instruments, wherein said method is for intensifying resonance of woodwind instruments in which cap holders are formed to the inside thereof and pads are combined with said cap holders, said method compring:
an agitation step for agitating a mixture of a conductive medium that contains at least one of platinum, gold, silver, copper, nickel, bronze, brass, phosphor bronze with solid silicon;
a mixture heating step for heating the agitated mixture;
a coagulation step for naturally cooling the heated mixture and coagulating it into a solid;
a mixture pulverization step for pulverizing the mixture;
a mixture application step for applying the mixture to the cap holder or the pads; and
a pad attaching step for attaching a pad to the interior of the cap holder after the mixture application step.

33. Method for intensifying resonance of musical instruments according to claim 32, said method further comprises, following the said pulverization step of the mixture, a plating step whereby the interior of said cap holder is plated by a mixture that contains one or more of platinum, gold, silver, copper, nickel, bronze, brass and phosphor bronze.

34. Method for intensifying resonance of musical instruments, said method compring:
a step of forming a mixture in which methyl alcohol, powder for the conductive medium and adhesive solution are mixed;
a mixture applying step whereby said mixture formed as above is sprayed to the inside of an instrument; and
a rapidly drying step whereby said mixture applied to said instrument is quickly dried by pressurizing air with the use of an air compressor.

35. Method for intensifying resonance of musical instruments, in which said instruments are any of string instruments, woodwinds, brass instruments, pianos and Korean traditional instruments, wherein a metallic unit for the conductive medium or a metallic mixture for the conductive medium is more bonded, with the use of an adhesive, along with the interior or exterior surface of said instruments.

36. Method according to claim 35, wherein said metallic unit for the conductive medium or said metallic mixture for the conductive medium contains at least any one of platinum, gold, silver, copper, nickel, bronze, brass and phosphor bronze.

37. Method according to claim 35, wherein said metallic unit of the conductive medium or said metallic mixture of the conductive medium further contains a mixture mixed one or more of methyl alcohol, adhesive solution, silicone and glue.

38. Method according to claim 35, wherein said metallic unit of the conductive medium and said metallic mixture of the conductive medium are selected in any one of nano-scaled powder, ordinarily fine powder, line or plate, or solid lump.

39. A resonance-intensified instrument as a woodwind, in which pads are combined to the interior of said instrument in order to intensify resonance, being characterized in that a plurality of cap holders that support said pads are formed so that such multiplied pads are combined in the interior of said woodwind and these pads are combined to the inward direction of said cap holders, where a conductive medium structured as a mixture that contains one or more of platinum, gold, silver, copper, nickel, bronze, brass and phosphor bronze is combined between said cap holders and pads.

40. A resonance-intensified instrument according to claim 39, being characterized in that a mixture positioned between said cap holders and pads, which contains one or more of platinum, gold, silver, copper, nickel, bronze, brass and phosphor bronze, is plated to the interior of cap holders.

41. A resonance-intensified instrument, being characterized in that frontal plate and rear plate are connected through side plate in a way that the spatial portion can be formed to the interior part of said instrument, where a mixture in the powdered shape with nano particles mixed by both methyl alcohol and adhesive solution is applied to the conductive medium that is structured by any one of platinum, gold, silver, copper, nickel, bronze, brass and phosphor bronze in one or more plates among frontal plate, rear plate and side plate within said instrument.

42. A resonance-intensified instrument according to claim 41, being characterized in that the said string instrument is any one of violin, cello, viola, double bass and acoustic guitar in which a profile thereof is made out of wood in an acoustic shape.

43. A resonance-intensified instrument according to claim 41, being characterized in that, as for the said string instrument, a metallic unit for the conductive medium or a metallic mixture for the conductive medium is formed to sound post, base bar and end pins thereof.

44. A resonance-intensified instrument according to claim 41, being characterized in that a conductive medium is applied to the sound post that transmits vibrations of string supports to the rear plate, and the base bar facilitated in the rear part of the frontal plate that transmits vibrations over to the entire area of the frontal plate.

45. A resonance-intensified instrument as a piano, being characterized in that a soundboard is configured in one side thereof to its inward direction so that the spatial portion can be formed, where a mixture in the powdered shape with nano particles mixed by methyl alcohol and adhesive solution is applied to the conductive medium in the inside of the soundboard of said instrument, which is structured by any one of platinum, gold, silver, copper, nickel, bronze, brass and phosphor bronze.

46. A resonance-intensified instrument according to claim 45, being characterized in that said piano is made out of wood in an acoustic shape.
